(19) United States
(12) Patent Application Publication
(10) Pub. No.: US 2009/0304958 A1
(43) Pub. Date: Dec. 10, 2009

(54) SINGLE USE BIODEGRADABLE CONTAINER

(75) Inventor: John C. McNulty, Nutley, NJ (US)

Correspondence Address: Keohane & D'Alessandro, 1881 Western Avenue, Suite 180, Albany, NY, 12203, US

(73) Assignee: John C. McNutly, Nutley, NJ (US)

(21) Appl. No.: 12/478,186

(22) Filed: Jun. 4, 2009

Related U.S. Application Data
(60) Provisional application No. 61/059,483, filed on Jun. 6, 2008.
(60) Provisional application No. 61/101,975, filed on Oct. 1, 2008.

(51) Int. Cl. B32B 1/02; B32B 27/10; B29D 22/00

(52) U.S. Cl. 428/34.2; 264/258; 264/129

(57) ABSTRACT

The present invention generally provides a single use, biodegradable container for storing solids, liquids, and/or gases. The container can be used for toxic, non-toxic, environmentally friendly and/or environmentally unfriendly materials. In a typical embodiment, the container comprises approximately three layers. The first layer is a slurry of paper (e.g., recycled newspapers) that is impregnated (e.g., sprayed) with a non toxic, environmentally friendly, oil and water repellant. The next layer of protection will be a harder (e.g., “coffee cup” like) layer of cardboard, also covered with the same oil and water repellant. The third layer will be a prefabricated container pressed from a mold, made of Biodegradable plastic. This third layer is typically sprayed with the oil and water repellant, made from, for example, Mater-B and PolyActide.

### CROSS-REFERENCE TO RELATED APPLICATION

The present invention claims the benefit of co-pending provisional patent application No. 61/059,483, filed Jun. 6, 2008, the entire contents of which are herein incorporated by reference.

### FIELD OF THE INVENTION

The present invention generally relates to a container such as for fluids (e.g., oil) or the like. Specifically, the present invention provides a single use biodegradable container

### BACKGROUND OF THE INVENTION

In recent years, an increased environmental awareness has led to the popular notion of “Going Green”. In this pursuit, making products recyclable or biodegradable has become a priority. The latter is especially difficult for products (e.g., containers) that are designed to hold other material such as fluids. This issue is compounded when the material in the container is environmentally unfriendly such as oil, gasoline, or the like. Existing containers fail to address such issues. In view of the foregoing, there exists a need for a solution that solves at least one of the problems of the related art.

### SUMMARY OF THE INVENTION

The present invention generally provides a single use, biodegradable container for storing solids, liquids, and/or gases. The container can be used for toxic, non-toxic, environmentally friendly and/or environmentally unfriendly materials. In a typical embodiment, the container body comprises approximately three layers. The first layer is a slurry of paper (e.g., recycled newspapers) that is impregnated (e.g., sprayed) with a non toxic, environmentally friendly, oil and water repellant. The next layer of protection will be a harder (e.g., “coffee cup” like) layer of cardboard, also covered with the same oil and water repellant. The third layer will be a prefabricated container pressed from a mold, made of Biodegradable plastic. This third layer is typically coated (e.g., sprayed) with the oil and water repellant, made from, for example, Mater-B and PolyActide.

A first aspect of the present invention comprises a single use biodegradable container, comprising: an opening for receiving a material to be stored; and a set of walls, each of the set of walls having: a first layer comprising a slurry, a second layer comprising cardboard, and a third layer comprising biodegradable plastic.

A second aspect of the present invention comprises a single use biodegradable container, comprising: an opening for receiving a material to be stored; and a container body having: a first layer comprising a slurry having paper, a second layer comprising cardboard, and a third layer comprising biodegradable plastic, the first layer the second layer and the third layer each being coated with an oil and water repellant.

A third aspect of the present invention provides a method for forming a single use biodegradable container, comprising: forming a container body by: forming a first layer comprising a slurry; forming a second layer comprising cardboard, and forming a third layer comprising biodegradable plastic; and forming an opening to the container body for receiving a material to be stored.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a top view of a single use biodegradable container according to the present invention.

FIG. 2 depicts side view of the single use biodegradable container of FIG. 1.

FIG. 3 depicts a top view of a single use biodegradable container after receiving a cover.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention generally provides a single use, biodegradable container for storing solids, liquids, and/or gases. The container can be used for toxic, non-toxic, environmentally friendly and/or environmentally unfriendly materials. In a typical embodiment, the container comprises approximately three layers. The first layer is a slurry of paper (e.g., recycled newspapers) that is impregnated (e.g., sprayed) with a non toxic, environmentally friendly, oil and water repellant. The next layer of protection will be a harder (e.g., “coffee cup” like) layer of cardboard, also covered with the same oil and water repellant. The third layer will be a prefabricated container pressed from a mold, made of Biodegradable plastic. This third layer is typically sprayed with the oil and water repellant, made from, for example, Mater-B and PolyActide.

The insides of the container will pitch to form a low spot and a spout leading to the exterior walls will be placed in this low spot. This way when the end user is pouring the liquid out of the container, nothing will remain in the container, leaving it 100% free of used oil. The container will hold approximately 5 US Qts of liquid. The container will have a flat bottom so it will not tip when placed on the ground under the vehicles engine block. There can be an (e.g., 8″) round opening on the top of the container so liquid can easily be transferred into the container, made of the same Biodegradable “Plastics”. Within that 8″ opening there will be multiple (e.g., 1/16″ w×¼″ h×8″) long bars that will span the width of the opening to prevent any matter, other than the liquid, to penetrate the opening. The opening will also have Biodegradable “teeth” that will allow a lid to be fastened to it for a single use application. Said lid will be made of the same Biodegradable plastic and will have holes cut out of it so it will be able to slide over the “teeth” that are on the base. The lid will then be turned in a (e.g., clockwise) direction until it snaps shut, sealing the container.

The container can have an outlet port/spout coming out of the side of its side that can be 1″ round and extends from the low point in the container ½″ from the exterior of the container that can be cut to open, allowing all of the liquid to be poured out of it and into a recycling tank. This container can then be thrown away by the attendant in the recycling center, causing no harm to the environment.

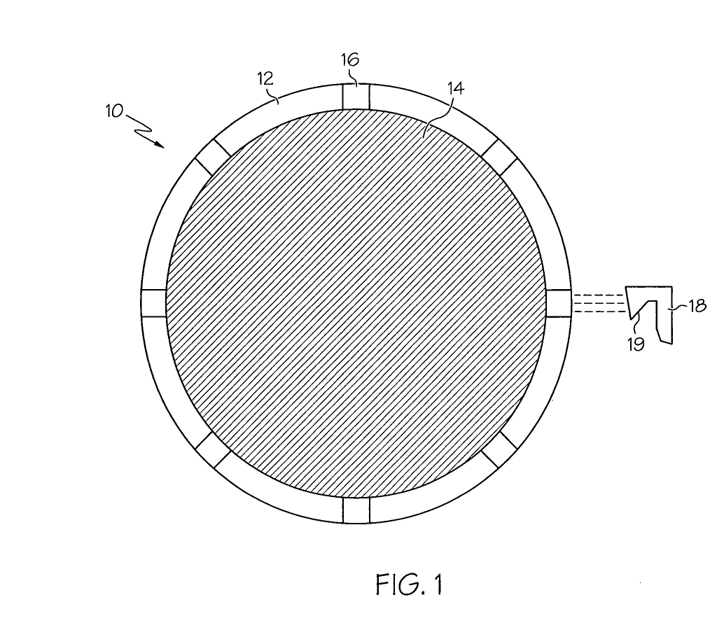

Referring now to FIG. 1, a top view of container 10 is shown. As depicted, container 10 has an opening for receiving material 14. The perimeter 12 of the opening includes various female connection receivers 16, which are capable of receiving complimentary male connection mechanisms 18 that are positioned on a cover (not shown in FIG. 1) in an interlocking fashion. Specifically, male type connection mechanisms 18 are configured with a protrusion 19 that is designed to lock into female connection receivers 16.

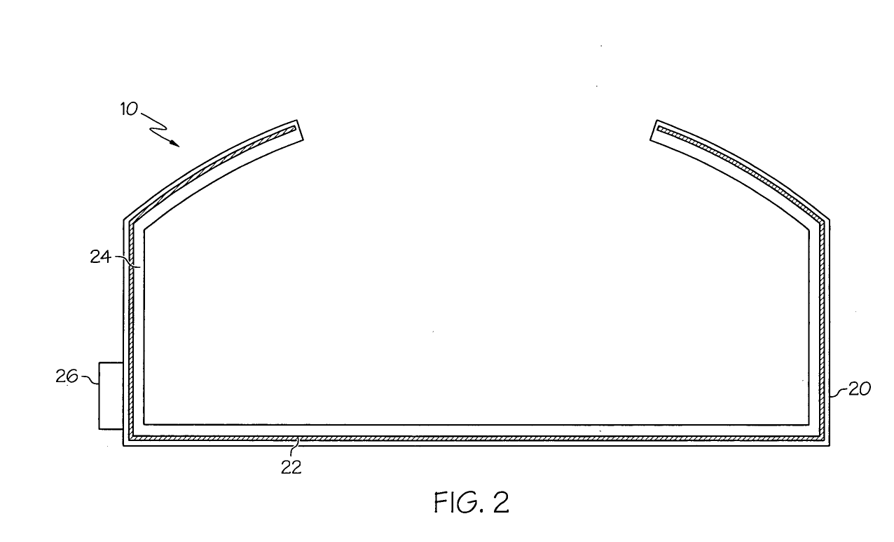

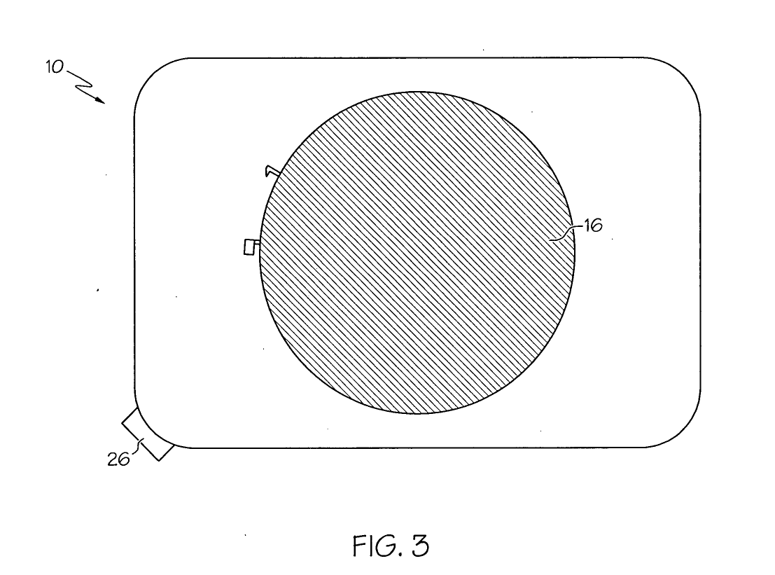

FIG. 2 depicts a side view of container 10. In general, container includes a container body comprises of a set (at least on) wall. Each wall generally has multiple layers 20, 22, and 24. Layer 24 is typically a slurry of paper (e.g., recycled newspapers) that is impregnated (e.g., sprayed) with a non toxic, environmentally friendly, oil and water repellant. Layer 22 is typically a harder (e.g., “coffee cup” like) layer of cardboard, also covered with the same oil and water repellant. Layer 20 will typically be a prefabricated container pressed from a mold, made of Biodegradable plastic. This third layer is typically sprayed with the oil and water repellant, made from, for example, Mater-B and PolyActide. As further shown in FIG. 2, an outlet port 26 is provided for releasing any materials in container 10. FIG. 3 shows a top view of container 10 with cover 16 in place. Cover 16 is secured to container 10 by locking male connection mechanisms 18 (FIG. 1) into female connection receivers. Once again, materials can be released via outlet port 26.

What is claimed is:

1. A single use biodegradable container, comprising:
an opening for receiving a material to be stored; and
a container body having:
a first layer comprising a slurry,
a second layer comprising cardboard, and
a third layer comprising biodegradable plastic.

2. The single use biodegradable container of claim 1, the opening being surrounded by a perimeter capable of receiving a cover.

3. The single use biodegradable container of claim 2, the perimeter comprising a set of female connectors for receiving male connectors on the cover in an interlocking fashion.

4. The single use biodegradable container of claim 1, the slurry comprising paper slurry.

5. The single use biodegradable container of claim 1, the first layer, the second layer, and the third layer being coated with a non-toxic, environmentally friendly oil and water repellant.

6. The single use biodegradable container of claim 1, the non-toxic, environmentally friendly oil and water repellant being selected from a group consisting of Mater-B and PolyActide.

7. The single use biodegradable container of claim 1, further comprising an outlet port for releasing the material.

8. A single use biodegradable container, comprising:
an opening for receiving a material to be stored; and
a container body having:
a first layer comprising a slurry having paper,
a second layer comprising cardboard, and
a third layer comprising biodegradable plastic, the first layer the second layer and the third layer each being coated with an oil and water repellant.

9. The single use biodegradable container of claim 8, the opening being surrounded by a perimeter capable of receiving a cover.

10. The single use biodegradable container of claim 9, the perimeter comprising a set of female connectors for receiving male connectors on the cover in an interlocking fashion.

11. The single use biodegradable container of claim 8, the slurry comprising paper slurry.

12. The single use biodegradable container of claim 8, the oil and water repellant being a non-toxic, environmentally friendly oil and water repellant.

13. The single use biodegradable container of claim 8, the non-toxic, environmentally friendly oil and water repellant being selected from a group consisting of Mater-B and PolyActide.

14. The single use biodegradable container of claim 8, further comprising an outlet port for releasing the material.

15. A method for forming a single use biodegradable container, comprising:
forming a container body by:
forming a first layer comprising a slurry;
forming a second layer comprising cardboard, and
forming a third layer comprising biodegradable plastic; and
forming an opening to the container body for receiving a material to be stored.

16. The method of claim 15, further comprising coating the first layer, the second layer, and the third layer with oil and water repellant.

17. The method of claim 16, the oil and water repellant being a non-toxic, environmentally friendly oil and water repellant.

18. The method of claim 17, the non-toxic, environmentally friendly oil and water repellant being selected from a group consisting of Mater-B and PolyActide.

19. The method of claim 15, the slurry comprising paper slurry.

20. The method of claim 15, further comprising forming an outlet port in the container body for releasing the material.
